(19) United States
(12) Patent Application Publication
(10) Pub. No.: US 2002/0163329 A1
(43) Pub. Date: Nov. 7, 2002

(54) Method for estimating the magnetisation curve of an electromagnetic actuator for controlling an engine valve

(76) Inventors: Egidio D' Alpaos, Pieve D' Alpago (IT); Michele Morselli, Bologna (IT); Flavia D' Antonio, Bologna (IT)

Correspondence Address: VENABLE, BAETJER, HOWARD AND CIVILETTI, LLP, P.O. BOX 34385, WASHINGTON, DC, 20043-9998, US

(21) Appl. No.: 10/073,258

(22) Filed: Feb. 13, 2002

(30) Foreign Application Priority Data
Feb. 13, 2001 (IT) BO2001A 000077

(51) Int. Cl. H01F 5/00; G01B 7/14

(52) U.S. Cl. 324/207.16; 123/90.11; 361/160

(57) ABSTRACT

Method for estimating the magnetisation curve of an electromagnetic actuator for controlling an engine valve, according to which a solenoid is activated by a current determined in order to attract an actuator body and place the actuator body in contact with the solenoid; the current is gradually reduced until the actuator body detaches from the solenoid and the corresponding values assumed by the magnetic flow crossing a magnetic circuit consisting of the solenoid and the actuator body are determined for at least some of the current values.

### CROSS REFERENCE TO RELATED APPLICATION

This application claims the priority of Italian Application No. B02001A 000077 filed Feb. 13, 2001, the disclosure of which is being incorporated herein by reference.

### BACKGROUND OF THE INVENTION

The present invention concerns a method for estimating the magnetisation curve of an electromagnetic actuator for controlling an engine valve.

As is known, internal combustion engines of the type described in the Italian patent application B099A000443 registered on Aug. 4, 1999, in which the movement of the inlet and exhaust valves is performed by electromagnetic actuators, are currently being tested. Said electromagnetic actuators have undoubted advantages as they permit control of each valve according to a law optimised for any engine operating condition, whereas the traditional mechanical actuators (typically cam shafts) require the definition of a valve lift profile representing an acceptable compromise for all possible engine operating conditions.

An electromagnetic actuator for a valve of an internal combustion engine of the type described above normally comprises at least one solenoid designed to move an actuator body made of ferromagnetic material and mechanically connected to the stem of the respective valve. To apply a particular law of motion to the valve, a control unit drives the solenoid with a current that can vary over time in order to appropriately move the actuator body.

From tests it has been observed that to obtain a relatively high precision in control of the valve, the position of the actuator body must be controlled in feedback; it is therefore necessary to have an accurate and substantially real reading over time of the position of the actuator body. Methods for estimating the position of the actuator body have therefore been proposed based on measurement of the electrical quantities (voltage and current) of the electrical circuits coupled to the drive solenoid, and on the knowledge of the functional characteristics, in particular the magnetisation curve, of the drive solenoid magnetic circuit.

At present the magnetisation curve of the drive solenoid is measured for each individual solenoid before fitting the solenoid in the engine; this procedure, however, does not take account of the effects produced on the solenoid by ageing and fitting in the engine. Measurement of the magnetisation curve for each individual solenoid after fitting in the engine has also been proposed; this procedure, however, is costly as measurement on the assembled engine is complicated and in any case does not take account of the effects produced on the solenoid by ageing.

### SUMMARY OF THE INVENTION

The aim of the present invention is to provide a method for estimating the magnetisation curve of an electromagnetic actuator for controlling an engine valve, which has none of the disadvantages described and which is, in particular, easy and inexpensive to implement.

According to the present invention a method for estimating the magnetisation curve of an electromagnetic actuator for controlling an engine valve is provided, according to claim 1.

### BRIEF DESCRIPTION OF THE DRAWINGS

The present invention will now be described with reference to the attached drawings, which illustrate a non-restrictive implementation example, in which:

FIG. 1 is a schematic view, with side and partially sectioned elevation, of an engine valve and a related electromagnetic actuator operating according to the method subject of the present invention;

FIG. 2 is a schematic view of a control unit of the actuator of FIG. 1;

FIG. 3 schematically illustrates an electromagnetic circuit of the control unit of FIG. 2;

FIG. 4 schematically illustrates an electrical circuit modelling the behaviour of eddy currents induced in the electromagnetic actuator of FIG. 1;

FIG. 5 shows graphs relating to the time evolution of some quantities characteristic of the electromagnetic actuator of FIG. 1;

FIG. 6 illustrates, in enlarged scale, a detail of the graphs of FIG. 5; and

FIG. 7 is a graph of the magnetisation curve of the electromagnetic actuator of FIG. 1 estimated by applying the method subject of the present invention.

### DETAILED DESCRIPTION OF THE INVENTION

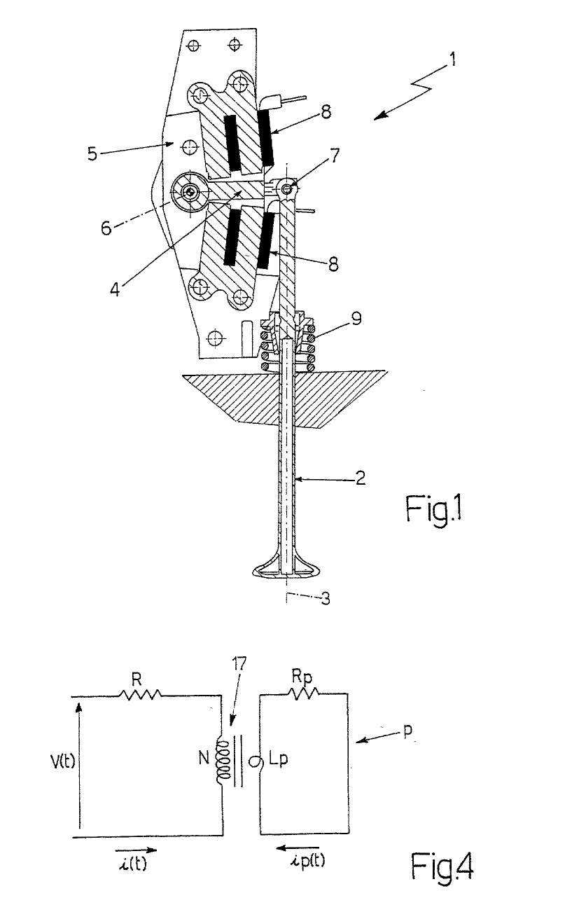

In FIG. 1, ref. no. 1 indicates overall an electromagnetic actuator 1 (of the type described in the Italian patent application B099A000443 filed on Aug. 4, 1999) coupled with an inlet or exhaust valve 2 of an internal combustion engine of known type to move the valve 2 along a longitudinal axis 3 of the valve between a closed position (known and not illustrated) and a maximum opening position (known and not illustrated).

The electromagnetic actuator 1 comprises an arm 4 that swivels at least partially, made of ferromagnetic material, the first end of which is hinged to a support 5 so that it can swivel around an axis 6 with rotation perpendicular to and not in the same plane as the longitudinal axis 3 of the valve 2, and the second end of which is connected via a hinge 7 to an upper end of the valve 2. The electromagnetic actuator 1 comprises, furthermore, two solenoids 8 set to a fixed position by the support 5 so that they are arranged on opposite sides of the swivel arm 4, and a spring 8 coupled with the valve 2 and designed to keep the swivel arm 4 in an intermediate position (illustrated in FIG. 1) in which said swivel arm 4 is equidistant from the pole pieces 10 of the two solenoids 8.

According to a different form of embodiment not illustrated, the spring 9 coupled to the valve 2 is positioned alongside by a torsion bar spring coupled with the hinge present between the support 5 and the swivel arm 4.

During use, the solenoids 8 are controlled by a control unit 11 (illustrated in FIG. 2) in such a way as to exercise alternatively or simultaneously a magnetic force of attraction on the swivel arm 4, causing it to rotate around the rotation axis 6, consequently moving the valve 2 along the respective longitudinal axis 3 and between the above-mentioned maximum opening and closing positions (not illustrated). In particular, the valve 2 is in said closed position (not illustrated) when the swivel arm 4 stops against the upper solenoid 8, in the maximum opening position (not illustrated) when the swivel arm 4 stops against the lower solenoid 8 and in a partially open position when the two solenoids 8 are both disconnected and the swivel arm 4 is in said intermediate position (illustrated in FIG. 1) due to the force exerted by the spring 9.

The control unit 11 controls in feedback and in a substantially known way the position of the swivel arm 4, i.e. the position of the valve 2, according to the engine operating condition.

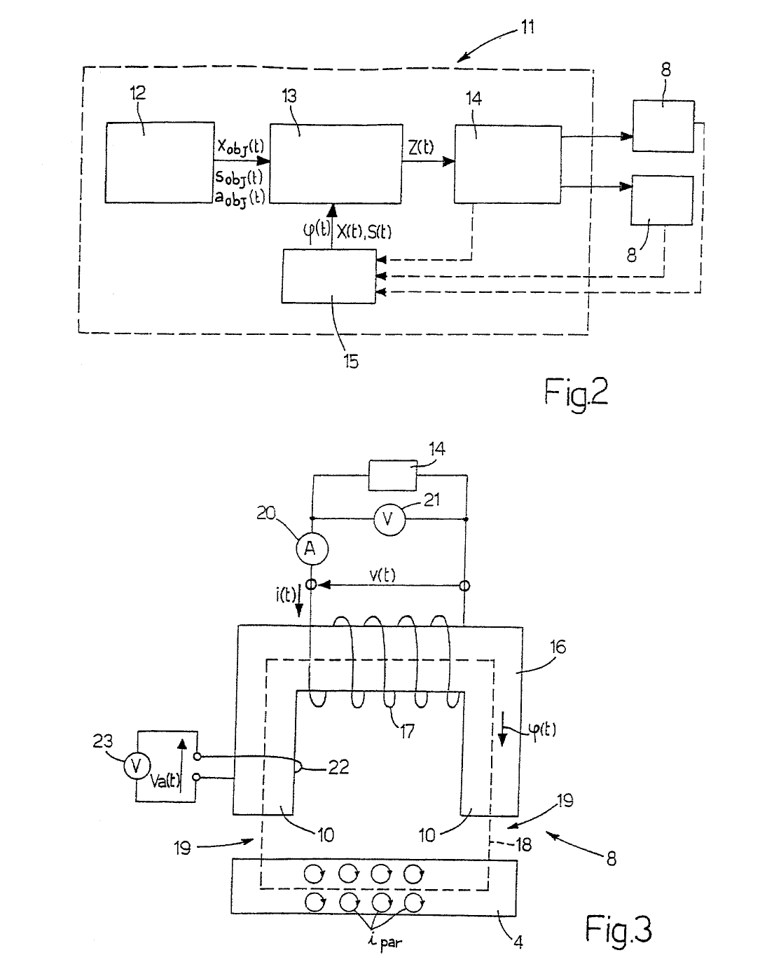

In particular, according to the illustrations of FIG. 2, the control unit 11 comprises a reference generation block 12, a calculation block 13, a drive block 14 designed to power the solenoids 8 with a current that can vary over time, and an estimation block 15 designed to estimate substantially in real time the position x (t) and the speed s (t) of the swivel arm 4 by measuring the electrical quantities of the drive block 14 and/or of the two solenoids 8. According to the illustrations of FIG. 3, each solenoid 8 comprises a respective magnetic core 16 coupled with a corresponding coil 17, which is powered by the drive block 14 according to the commands received from the calculation block 13.

During use, the reference generation block 12 receives at input a number of parameters indicating the engine operating conditions (for example the load, the number of revs, the position of the throttle body, the angular position of the drive shaft, the temperature of the cooling liquid) and provides the calculation block 13 with an objective value x_{R}(t) (i.e. a desired value) of the position of the swivel arm 4 (and therefore of the valve 2).

According to the objective value x_{R}(t) and estimated value x (t) of the position of the swivel arm 4 received from the estimation block 15, the calculation block 13 processes and sends to the drive block 14 a command signal z (t) for driving the solenoids 8.

The swivel arm 4 is positioned between the pole pieces 10 of the two solenoids 8, which are set by the support 5 to a fixed position and at a fixed distance from each other, therefore the estimated value x (t) of the position of the swivel arm 4 can be directly obtained by means of a simple algebraic sum from an estimated value d (t) of the distance existing between a given point of the swivel arm 4 and a corresponding point of one of the two solenoids 8.

With particular reference to FIG. 3, which illustrates one single solenoid 8, the methods used by the estimation block 15 to calculate an estimated value d (t) of the distance existing between a given point of the swivel arm 4 and a corresponding point of the solenoid 8 are described below.

During use, when the drive block 14 applies a voltage v (t) which can vary over time at the terminals of the coil 17 of the solenoid 8, said coil 17 is crossed by a current i (t), consequently generating a flow Φ (t) through a magnetic circuit 18 coupled with the coil 17. In particular the magnetic circuit 18 coupled with the coil 17 consists of the core 16 of ferromagnetic material of the solenoid 8, the swivel arm 4 made of ferromagnetic material and the magnetic gap 19 existing between the core 16 and the swivel arm 4.

The magnetic circuit 18 has an overall reluctance R defined by the sum of the reluctance of the iron R_{fe} and the reluctance of the magnetic gap Rₒ (equation [2]); the value of the flow φ (t) that circulates in the magnetic circuit 18 is linked to the value of the current i (t) that circulates in the coil 17 by the equation [1], in which N is the number of turns of the coil 17 and hₚ (t) is a contribution of ampere turns due to any eddy currents iₚₐᵣ induced in the swivel arm 4:

[1] N* i (t)+hₚ(t)=R* Φ(t)

[2] R=R_{fe}+R₀

In general the value of the overall reluctance R depends both on the position x (t) of the swivel arm 4 (i.e. on the amplitude of the magnetic gap 19, which is equal to the position x (t) of the swivel arm 4 or differs from said position by a fixed constant value) and on the value assumed by the flow Φ (t). Barring negligible errors into account, i.e. as an initial approximation, it can be maintained that the value of the reluctance of the iron R_{fe} depends only on the value assumed by the flow Φ (t), while the reluctance value of the magnetic gap Rₒ depends only on the position x (t), i.e.:

[3]R(x(t), Φ(t))=R_{fe}(Φ(t))+R₀(x(t))

[4] N* i(t)+hₚ(t)=R(x(t), Φ(t))* Φ(t)

[5] N* i(t)+hₚ(t)=R_{fe}(Φ(t))* Φ(t)+R₀(x(t))* Φ(t)

[6] N* i(t)+hₚ(t)=H_{fe}(Φ(t))+R₀(x(t))* Φ(t)

Solving the equation [6] with respect to Rₒ(x(t)), the reluctance value at the magnetic gap Rₒ can be obtained given that an estimation of the contribution hₚ(t) of ampere turns due to the eddy currents iₚₐᵣ is known, that the value of the current i (t) is known, a value which can be easily measured by means of an ammeter 20, that the value of the number N of turns is known (fixed and depending on the construction characteristics of the coil 17), that the value of the flow Φ (t) is known and that the relationship existing between the reluctance of the iron R_{fe} and the flow Φ is known, i.e. that the magnetisation curve C of the iron part of the magnetic circuit 18 is known.

The relationship existing between reluctance at the magnetic gap Rₒ and the position x can be obtained fairly simply by analysing the characteristics of the magnetic circuit 18 (an example of a model of the behaviour of the magnetic gap 19 is shown by equation [8]). Once the relationship between the reluctance at the magnetic gap Rₒ, and the position x is known, the position x can be obtained from the reluctance at the magnetic gap Rₒ by applying the inverse relation, which is applicable both by using the exact equation and by using an approximate numerical calculation method. The above can be summarised in the following equations (in which the constants K₀, K₁, K₂, K₃ are constants that can be obtained experimentally by means of a set of measurements on the magnetic circuit 18):

$${R}_{o} ( x ( t ) ) = \frac{N \cdot i ( t ) + {h}_{p} ( t ) - {H}_{fe} ( ϕ ( t ) )}{ϕ ( t )} \qquad [ 7 ]$$

[8] Rₒ(x(t))=K₁[1−e^{-k}^{₂}^{·}x(t)+k₃·X(t)]+Kₒ

$$x ( t ) = {R}_{0}^{- 1} ( {R}_{o} ( x ( t ) ) ) = {R}_{0}^{- 1} ( \frac{N \cdot i ( t ) + {h}_{p} ( t ) - {H}_{fe} ( ϕ ( t ) )}{ϕ ( t )} ) \qquad [ 9 ]$$

From the above, it is clear that if the flow Φ (t) can be measured, it is possible to calculate relatively simply the position x (t) of the swivel arm 4. Furthermore, starting from the value of the position x (t) of the swivel arm 4, it is possible to calculate the value of the speed s (t) of said swivel arm 4 by means of a simple time derivation operation of position x (t).

According to a preferred embodiment, to measure the flow Φ (t) at the magnetic core 16 an auxiliary coil 22 is coupled (consisting of at least one turn and generally provided with a number Nₐ of turns), at the terminals of which a further voltmeter 23 is connected; since the terminals of the coil 22 are substantially open (the internal resistance of the voltmeter 23 is so high that it can be considered infinite without introducing appreciable errors), the coil 22 is not crossed by current and the voltage va (t) at its terminals depends solely on the derivative of the flow Φ (t) over time, from which the flow can be obtained via an integration operation.

$$\begin{matrix}\frac{ⅆ ϕ ( t )}{ⅆ t} = \frac{1}{{N}_{a}} \cdot {v}_{a} ( t ) & [ 10 ] \\ ϕ ( T ) = \frac{1}{{N}_{a}} \cdot {\int }_{0}^{T} {v}_{a} ( t ) ⅆ t + ϕ ( 0 ) & [ 11 ]\end{matrix}$$

The conventional moment 0 is chosen in order to know the precise value of the flow Φ(0) at the moment 0 itself; in particular the moment 0 is normally chosen within a time range in which the coil 17 is not crossed by current and, therefore, the flow Φ is substantially nil (the effect of any residual magnetisation is negligible), or it is chosen corresponding to a given position of the swivel arm 4 (typically when the swivel arm 4 stops against the pole pieces 10 of the solenoid 8), corresponding to which the value of the position x is known and therefore the value of the flow Φ is known.

Lastly, it is useful to note that the method described above for estimating the position x (t) can be used only when the coil 17 of a solenoid 8 is crossed by current. For this reason, as described above, the estimation block 15 operates with both solenoids 8, so as to use the estimation performed with one solenoid 8 when the other one is off.

When both solenoids 8 are active, the estimation block 15 takes an average of the two values x (t) calculated with the two solenoids 8, weighted if necessary according to the precision attributed to each value x (t) (generally estimation of the position x with respect to a solenoid 8 is more accurate when the swivel arm 4 is near the pole pieces 10 of said solenoid 8).

To estimate the contribution hₚ(t) of ampere turns of the eddy currents iₚₐᵣ, it is possible to model said eddy currents iₚₐᵣ with one single equivalent eddy current iₚ(t) which circulates in one single equivalent turn p (illustrated in FIG. 4) magnetically coupled to the magnetic circuit 18 in which the magnetic flow Φ(t) circulates; the turn p has its own resistance Rₚ, its own inductance Lₚ and is closed in short circuit. The values of the resistance Rₚ and inductance Lₚ of the turn p can be obtained fairly simply via a series of test measurements on the solenoid 8. Obviously the turn p is magnetically coupled also with the power coil 17 of the solenoid 8, said coil 17 having N turns and its own resistance RES.

The equations that describe the electrical circuit of the coil 17 and turn p are given by applying Ohm's general law:

$$\begin{matrix}v ( t ) - RES \cdot i ( t ) = N \cdot \frac{ⅆ ϕ ( t )}{ⅆ t} & [ 12 ] \\ - {R}_{p} \cdot {i}_{p} ( t ) = \frac{ⅆ ϕ ( t )}{ⅆ t} + {L}_{p} \cdot \frac{ⅆ {i}_{p} ( t )}{ⅆ t} & [ 13 ]\end{matrix}$$

Going on to the L-transforms (Laplace transforms) and obtaining the transfer function of the current iₚ in the plane of the Laplace transforms we get:

[14] −Rₚ·Iₚ=s ·Φ+Lₚ·s ·Φ

$${I}_{p} = - \frac{s}{{L}_{p} \cdot s + {R}_{p}} \cdot Φ \qquad [ 15 ]$$

Once the values of the resistance Rₚ and inductance Lₚ of the turn p are known and once the value of the magnetic flow Φ (t) has been estimated via the method described above, the value of the equivalent eddy current iₚ(t) can be obtained simply by applying a known method of L-antitransformation; preferably, the value of the equivalent eddy current iₚ(t) is obtained by discretising the above equation and applying a numerical method (easy to implement via software).

It is evident that the equivalent eddy current iₚ(t) is applied to the magnetic circuit 18 circulating in one single equivalent p turn, therefore the equivalent eddy current iₚ(t) produces a contribution hₚ(t) of ampere turns equal to its intensity.

As appears evident from the equation [9], to precisely determine the position x (t) of the swivel arm 4 it is necessary to know, to a fairly accurate degree, the magnetisation curve C of the iron part of the magnetic circuit 18, i.e. the relation between the flow p and the reluctance R_{fe} of the iron or the ampere turns H_{fe} of the iron (H_{fe}(Φ(t))=R_{fe}(Φ(t))* Φ(t)) . In particular, precise knowledge of the magnetisation curve C of the iron part of the magnetic circuit 18 is all the more important the nearer the swivel arm 4 is to the magnetic core 16, as the weight of the ampere turns H_{fe} of the iron increases exponentially the nearer the swivel arm 4 moves to the magnetic core 16.

To determine with sufficient accuracy the magnetisation curve C of the iron part of a magnetic circuit 18, the control unit 11 waits for the swivel arm 4 to stop against the respective magnetic core 16; in this condition the magnetic gap 19 is substantially nil and the equation [6] becomes (assuming that we are operating in a static or almost static regime to annul the effect of the eddy current ipar):

[16] N* i(t)=Hfe(Φ(t))

Starting with the swivel arm 4 stopped against the magnetic core 16, the control unit 11 powers the corresponding coil 17 with a current slope i (t) with a relatively low inclination, i.e. variation in time, to substantially annul the influence of any dynamic effects. Since the number N of turns of the coil 17 is known from the construction characteristics of the solenoid 8, since the intensity of the current i (t) is known from the measurement of the ammeter 20, and since the value of the flow Φ (t) is known via the estimation method described above, it is clear that by applying the equation [16] it is possible to reconstruct in a simple fashion the magnetisation curve C of the iron part of the magnetic circuit 18.

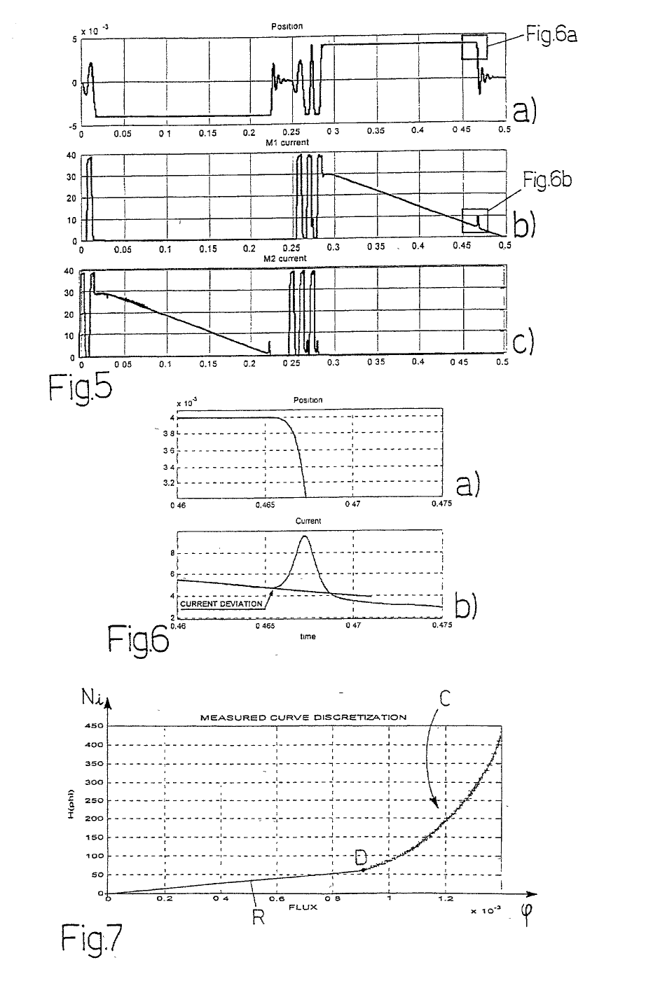

The procedure for reconstructing the magnetisation curve C of the iron part of a magnetic circuit 18 is described below with particular reference to FIGS. 5, 6 and 7 which show the time trends of some characteristic quantities of the solenoids 8 measured during a prototype bench test.

In particular, FIG. 5 illustrates the time trend of the position x (t) of the swivel arm 4 (graph called “Position” and marked by letter “a”), the time trend of the current i (t) in a solenoid 8 (graph called “M1 current” and marked by the letter “b”) and the time trend of the current i(t) in the other solenoid 8 (graph called “M2 current” and marked by the letter “c”). FIG. 6 illustrates a detail of the graphs 5a and 5b(detail highlighted by a box in said graphs 5a and 5b). FIG. 7 illustrates a magnetisation curve C of the iron part of a magnetic circuit 18 estimated by applying the above-described method.

Initially a solenoid 8 is powered by the control unit 11 with a relatively very high current i (t) to bring the swivel arm 4 to a stop against the respective magnetic core 16; initially the current i (t) is kept constant for a given time interval to annul any transients and subsequently said current is gradually reduced according to a decreasing slope with a relatively low inclination, i.e. variation in time, in order to substantially annul the influence of any dynamic effects. During said decreasing slope of the current i (t), the magnetisation curve C of the iron part of the magnetic circuit 18 is reconstructed, determining for each current value i (t) (equal to the value of ampere turns divided by the number N of turns) the corresponding value of the flow Φ (t).

When the current i (t), therefore the magnetic attraction force exerted by the solenoid 8, drops below a minimum holding threshold, the swivel arm 4 detaches from the magnetic core 16 due to the elastic forces exerted by the spring 9 and the above-described operations can be repeated to identify the magnetisation curve C of the other solenoid 8. Obviously, the lower end of the magnetisation curve C identified is defined by the detachment point D, which is diagnosed by identifying the slope variation of the curve of the current i (t) due to the counter electromotive effect induced by the movement of the swivel arm 4 in a magnetic field; the peak of the current i (t) following detachment of the swivel arm 4 is highlighted in FIG. 6.

Precise identification of the detachment point D is extremely useful in flow control of the impact speed s (t) of the swivel arm 4, as it provides the value of the objective flow Φ (t) corresponding to the contact between the swivel arm 4 and the magnetic core 16.

Following the procedures described above, the magnetisation curve C is identified up to the detachment point D corresponding to a relatively low value of the holding flow Φ(t); to complete the magnetisation curve C for flow Φ (t) values below the holding value, it is possible to use a linear approximation defined by a straight line R joining detachment point D with the origin of the axes corresponding to a nil flow (the ferromagnetic materials used in construction of the magnetic cores 16 and in construction of the swivel arm 4 have a negligible residual magnetisation) . This approximation is acceptable and introduces minimum errors, since for relatively low flow Φ (t) values, the magnetisation curve C has an almost linear trend. As an alternative to the straight line R, another more complex mathematical function can be used, for example a parabola, to approximate the trend of the magnetisation curve C; as an example, a condition of equality between the right and left derivatives of the magnetisation curve C corresponding to the detachment point D could be imposed.

The method described above for reconstruction of the magnetisation curve C allows us to take account of all the construction uncertainties of the solenoids 8 and of all the inevitable elastic deformations of the solenoids 8.

In particular the elastic deformations are due to the fact that normally the faces of the magnetic cores 16 and of the swivel arm 4 are not perfectly in the same plane, therefore contact will not take place simultaneously on all the points of the facing surfaces, but only on a limited area. By increasing the value of the flow Φ (t) beyond the essential minimum (called holding value) for ensuring contact, the force of attraction exerted on the swivel arm 4 increases; said increase in force causes an elastic deformation of the structure which tends to settle the facing surfaces, reducing the residual magnetic gap and, therefore, the overall reluctance R of the magnetic circuit 18 in those conditions. This variation in reluctance R is not matched, however, by a variation in the position x (t) of the swivel arm 4 (position x (t) which is the control variable of the control unit 11); the method described above for reconstruction of the magnetisation curve C therefore makes it possible to incorporate also the effects of the elastic deformations of the solenoids 8 in the magnetisation curve C, avoiding erroneously considering said elastic deformations as movements of the swivel arm 4.

Furthermore, the above-described method for reconstruction of the magnetisation curve C allows us to explore and accurately trace the section of the magnetisation curve C corresponding to the beginning of the material saturation zone which, in the case of a non-uniform but laminate structure and non-isotropic material, can be dispersed from magnet to magnet. Note that it is particularly useful to know precisely the saturation condition of the solenoids 8 to ensure correct reconstruction of the position x (t) of the swivel arm 4 also in the presence of flows Φ (t) considerably higher than the saturation flow which can occur during the opening command of a discharge valve against high counter pressure forces of the burnt gases.

Lastly, since the above-described method for estimating the magnetisation curve C can be repeated at the beginning of each work session, the variations in the system characteristics caused by ageing can be taken into consideration.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. Method for estimating the magnetisation curve (C) of an electromagnetic actuator (1) for controlling an engine valve (2); said method provides for activation of a solenoid (8) with a current (i) determined in order to attract an actuator body (4) and place said actuator body (4) in contact with the solenoid (8), gradual reduction of the current (i) until determining detachment of the actuator body (4) from the solenoid (8) and determination, for at least some values of the current (i), of the corresponding values assumed by the magnetic flow (Φ) crossing a magnetic circuit (18) consisting of the solenoid (8) and the actuator body (4).

2. Method according to claim 1, in which the magnetisation curve (C) comprises a set of points, each of which is defined by a pair of corresponding values of the magnetic flow (Φ) and of the current (i) or by a pair of corresponding values of the magnetic flow (Φ) and of the ampere turns (H_{fe}) produced by the current (i), the ampere turns (H_{fe}) produced by the current (i) being equal to the product of the current (i) for the number (N) of turns present in said solenoid (8).

3. Method according to claim 2, in which said magnetisation curve (C) is approximated by a mathematical function (R) in the section between the point corresponding to a nil value of the magnetic flow (Φ) and a point (D) corresponding to said detachment of the actuator body (4) from the solenoid (8).

4. Method according to claim 3, in which said mathematical function (R) is a straight line.

5. Method according to claim 3, in which said mathematical function (R) is a parabola.

6. Method according to claim 1, in which said current (i) is reduced according to a slope law with constant inclination in time, the time derivative of said current (i) being kept below a given value to substantially annul the effect of dynamic phenomena.

7. Method according to claim 1, in which the moment of said detachment of the actuator body (4) from the solenoid (8) is determined by identifying the occurrence of an impulse peak in said current (i).

8. Method according to claim 1, in which said current (i) is kept constant for a certain interval of time before being gradually reduced.

9. Method according to claim 1, in which the value of the magnetic flow (Φ) is determined by measuring the value assumed by some electrical quantities (i, v; vₐ) of an electrical circuit (17; 22) coupled with the magnetic circuit (18), calculating the time derivative of the magnetic flow (Φ) as a linear combination of the values of the electrical quantities (i, v; vₐ), and integrating in time the derivative of the magnetic flow (Φ).

10. Method according to claim 9, in which the voltage (vₐ) present at the terminals of an auxiliary coil (22) coupled with the magnetic circuit (18) and linking the magnetic flow (Φ) is measured, the auxiliary coil (22) being substantially electrically open and the time derivative of the magnetic flow (Φ) and the magnetic flow (Φ)itself being calculated by applying the following formulas:
$$\frac{ⅆ ϕ ( t )}{ⅆ t} = \frac{1}{Na} \cdot {v}_{aus} ( t )$$
$$ϕ ( T ) = \frac{1}{{N}_{a}} \cdot {\int }_{0}^{T} {v}_{aus} ( t ) ⅆ t + ϕ ( 0 )$$
in which:
Φ is the magnetic flow (Φ)
Na is the number of turns of the auxiliary coil (22)
Vₐ is the voltage present at the terminals of the auxiliary coil (22) .
